(19) United States
(12) Patent Application Publication
(10) Pub. No.: US 2025/0313433 A1
(43) Pub. Date: Oct. 9, 2025

(54) A SEAL ASSEMBLY FOR AN ELEVATOR AND A METHOD TO OPERATE THE SAME

(71) Applicant: RUPHAVATHY VISHAL, CHENNAI (IN)

(72) Inventor: RUPHAVATHY VISHAL, CHENNAI (IN)

(21) Appl. No.: 18/292,041

(22) PCT Filed: Nov. 17, 2023
(86) PCT No.: PCT/IB2023/061636

§ 371 Date: Jan. 25, 2024

(30) Foreign Application Priority Data
Dec. 30, 2022 (IN) 202241077149

(51) Int. Cl. B66B 11/02; B66B 9/04; F16J 15/3284

(52) U.S. Cl. CPC B66B 11/0226; B66B 9/04; F16J 15/3284

(57) ABSTRACT

A seal assembly 100 for an elevator 200 is disclosed. The seal assembly includes a covering structure 102. The covering structure covers a top portion of the elevator. The covering structure includes a plurality of grooves 104 and a seal mould 106. The plurality of pairs of grooves is disposed on a peripheral portion of the covering structure 102. Each plurality of pairs of grooves is positioned diametrically opposite each other. The seal mould operatively coupled with the plurality of pairs of grooves. The seal mould is adapted to position on the peripheral portion of the covering structure at a clearance between a wall 108 of each groove of the plurality of pairs of grooves and a sealing material.

### CROSS-REFERENCE TO RELATED APPLICATION

This Application claims priority from a Complete Patent application filed in India having Patent Application No. 202241077149, filed on Dec. 30, 2022, and titled “A SEAL ASSEMBLY FOR AN ELEVATOR AND A METHOD TO OPERATE THE SAME” and a PCT Application No. PCT/IB2023/061636 filed on Nov. 17, 2023, and titled “A SEAL ASSEMBLY FOR AN ELEVATOR AND A METHOD TO OPERATE THE SAME.”

### FIELD OF INVENTION

Embodiments of the present disclosure relate to elevators and more particularly to a seal assembly for elevators and a method to operate the same.

### BACKGROUND

An elevator moves in a vertical shaft to carry passengers or freight between the levels of a multi-storey building. The pneumatic vacuum elevator uses air pressure to cause motion of the passenger cabin within a thoroughfare or tubular cylinder. The mechanism uses the air within the tubular cylinder as a working fluid. Brakes, motors, valves, electronic controls and other equipment work in tandem to ensure a safe and pleasant riding experience for each occupant therein. In addition, the unnecessary braking of elevator and speed-raising also increases the extra mechanical wear of elevator, thereby have reduced the service life of elevator. Various components of the elevator include a cabin, a controller, a sealing unit, and the like

A seal assembly is an important equipment attached on top of a pneumatic vacuum elevator. The seal assembly enables a frictionless movement and an easy elevation of the cabin due to the pneumatic depression generated on the upper part of the tubular cylinder. In operation, the elevator cabin undergoes a rough transition as the cabin moves from one location to another. Associated movement experience vibration as the elevator cabin transports.

Although, the currently known sealing units or assemblies reduces vibrations during the movement of the cabin while sealing the cabin in elevator cylinder. There is need of a sealing unit the is efficient in reducing vibrations of the elevator cabin. There is need of a sealing unit that is simple and mounted easily in the elevators. There is need of a sealing unit that provides tight sealing to the elevator.

Hence, there is a need for a seal assembly for elevators and a method to operate the same to address the aforementioned issue(s).

### BRIEF DESCRIPTION

In accordance with an embodiment of the present disclosure, a seal assembly for an elevator is provided. The seal assembly includes a covering structure. The covering structure is configured to cover a top portion of the elevator. The covering structure includes a plurality of pairs of grooves and a seal mould. The plurality of pairs of grooves is disposed on a peripheral portion of the covering structure. Each plurality of pairs of grooves is positioned diametrically opposite each other. The seal mould is operatively coupled with the plurality of pairs of grooves. The seal mould is adapted to position on the peripheral portion of the covering structure at a clearance between a wall of each groove of the plurality of pairs of grooves and a sealing material.

In accordance with another embodiment of the present disclosure, a method for operating a seal assembly for the elevator is provided. The method includes covering, by a covering structure, a top portion of an elevator. The method also includes disposing, a plurality of pairs of grooves on a peripheral portion of the covering structure. Each of the plurality of pairs of grooves is positioned diametrically opposite to each other. Further, the method includes sealing, by a seal mould, on the peripheral portion of the covering structure at a clearance between a wall of each groove of the plurality of pairs of grooves and a sealing material.

In accordance with yet another embodiment of the present disclosure, a pneumatic vacuum is provided. The pneumatic vacuum elevator includes an external cylinder assembly, a guide rail pillar, a polycarbonate sheet, a seal assembly, and an electronic control unit. The external cylindrical assembly includes an elevator cabin inserted therein, wherein the external cylinder assembly further includes a plurality of cylinders coupled using a base ring assembly and a band ring assembly. The guide rail pillar is mechanically coupled to the elevator cabin. The guide rail pillar is disposed at the external cylinder assembly. The guide rail pillar is configured to guide an actuation of the elevator cabin. The polycarbonate sheet is configured to cover the external cylinder assembly. The polycarbonate sheet and the external cylinder assembly is coupled using a first locking device and a second locking device. The first locking device is configured to lock an air gap between the polycarbonate sheet, the base ring assembly, and the external cylinder assembly and the second locking device is configured to lock an air gap between the polycarbonate sheet and the guide rail pillar a seal assembly adapted to fit over a top portion of the elevator cabin. The seal assembly is configured to seal the elevator cabin to reduce vibrations during the upward and downward movement of the elevator cabin. The seal assembly includes a covering structure. The covering structure is configured to cover a top portion of the elevator. The covering structure includes a plurality of pairs of grooves and a seal mould. The plurality of pairs of grooves is disposed on a peripheral portion of the covering structure. Each of the plurality of pairs of grooves is positioned diametrically opposite to each other. The seal mould is operatively coupled with the plurality of pairs of grooves. The seal mould is adapted to position on the peripheral portion of the covering structure at a clearance between a wall of each groove of the plurality of pairs of grooves and a sealing material. The electronic control unit is located on top of the external cylinder assembly. The electronic control unit controls the movement of the elevator.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a seal assembly in accordance with an embodiment of the present disclosure;

FIG. 2 is a schematic representation of a cross-sectional view of a groove of a plurality of pairs of grooves of FIG. 1 in accordance with an embodiment of the present disclosure;

FIG. 3 is a schematic representation of a cross-sectional view of an arc of the covering structure of FIG. 1 in accordance with an embodiment of the present disclosure;

FIG. 4 is a schematic representation of a pneumatic vacuum elevator in accordance with an embodiment of the present disclosure;

FIG. 5 is a schematic representation of a seal assembly corresponding to the pneumatic vacuum elevator in accordance with an embodiment of the present disclosure; and

FIG. 6 is a flow chart representing the steps involved in a method for operating a seal assembly of the elevator in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a seal assembly for an elevator and a method to operate the same. The seal assembly includes a covering structure. The covering structure is configured to cover a top portion of the elevator. The covering structure includes a plurality of pairs of grooves and a seal mould. The plurality of pairs of grooves is disposed on a peripheral portion of the covering structure. Each plurality of pairs of grooves is positioned diametrically opposite each other. The seal mould is operatively coupled with the plurality of pairs of grooves. The seal mould is adapted to position on the peripheral portion of the covering structure at a clearance between a wall of each groove of the plurality of pairs of grooves and a sealing material.

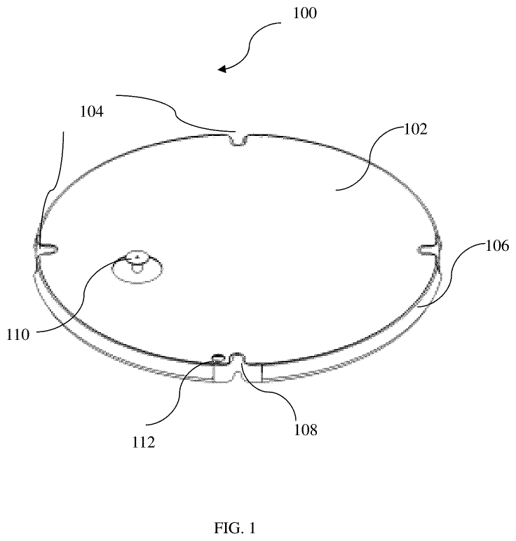

FIG. 1 is a schematic representation of a seal assembly 100 in accordance with an embodiment of the present disclosure. The seal assembly 100 includes a covering structure 102. The covering structure 100 is configured to cover a top portion of the elevator 200. In one embodiment, the covering structure 102 is configured to provide a covering to the elevator cabin 220 structural from sideways. The covering structure 102 includes a plurality of pairs of grooves 104 disposed on a peripheral portion of the covering structure 102. Each of the plurality of pairs of grooves 104 is positioned diametrically opposite to each other. In one embodiment, the covering structure 102 is circular in shape forming an arc between two adjacent grooves of the plurality of pair of groves 104.

The seal mould is 106 operatively coupled with the plurality of pairs of grooves 104. The seal mould 106 is adapted to position on the peripheral portion of the covering structure 102 at a clearance between a wall 108 of each groove of the plurality of pairs of grooves 104 and a sealing material. In one embodiment, the plurality of pairs of grooves 104 comprises U-shaped grooves. In one embodiment, the sealing material is comprised of a rubber material for providing a tight sealing. In another embodiment, the seal mould 106 is continuously sealed with the sealing material along a peripheral portion thereof.

In one embodiment, the seal assembly 100 includes a protruding portion 110 positioned at an offset from a centre portion of the covering structure 102. In one embodiment, the protruding portion 110 is protruded perpendicular to the covering structure 102. In another embodiment, the protruding portion 110 includes a circular crown positioned at the offset from the centre of the covering structure 102. In yet another embodiment, a slot 112 positioned adjacent to a groove of the plurality pairs of grooves 104.

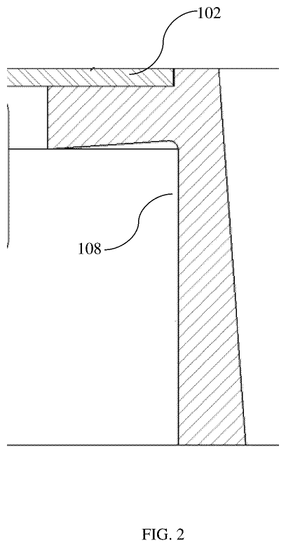

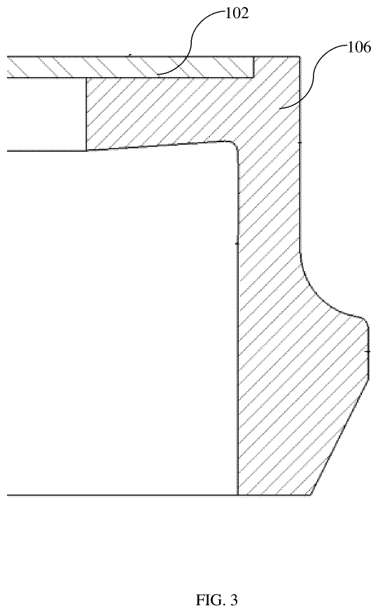

FIG. 2 is a schematic representation of a cross-sectional view of a groove of a plurality of pairs of grooves 104 of FIG. 1 in accordance with an embodiment of the present disclosure. FIG. 3 is a schematic representation of a cross-sectional view of an arc of the covering structure 102 of FIG. 1 in accordance with an embodiment of the present disclosure. In one embodiment, the constant touching of the seal mould 106 with an inner wall of the elevator cylinder (not shown in FIG. 1) enables the tight sealing of the cylindrical elevator cabin 220. In addition to that, the sealing mould 106 reduces vibrations during upward and downward movement while maintaining sealing of the cylindrical elevator cabin 220. In one specific embodiment, at least one sealing material is fabricated with a soft rubberized material for complete sealing.

In an exemplary embodiment, the covering structure 102 includes a plurality of plates (not shown in FIG. 1). The plurality of plates is mechanically coupled at a pre-determined gap over the covering structure 102. The plurality of plates enables holding of the seal assembly 100 over the top surface of the elevator cabin 220 during upward and downward movement.

In operation, as the elevator cabin 220 is powered upward and downward through the external cylinder assembly 210, the seal assembly 100 enables easy control of the movement. The sealing mould 106 plates enable a smooth ride without vibration as they are rubberized and tightly packed with the external cylinder assembly 210. During the motion of the elevator cabin 220 the reinforcement bars adds structural integrity to the seal assembly as they are tightly sealed with the external cylinder assembly 210.

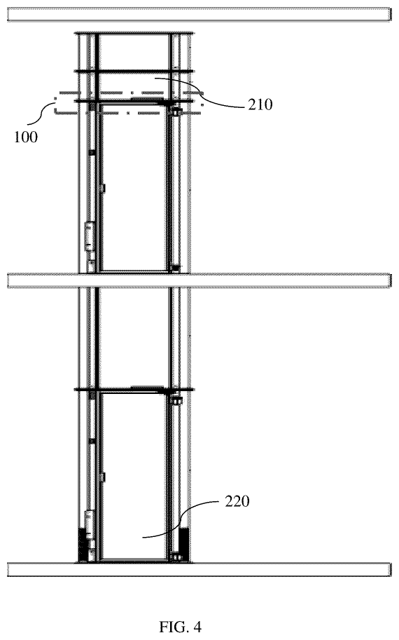

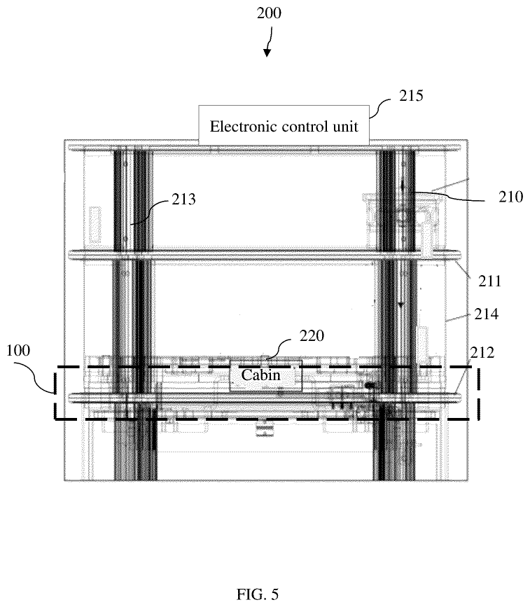

FIG. 4 is a schematic representation of a pneumatic vacuum elevator 200 in accordance with an embodiment of the present disclosure. FIG. 5 is a schematic representation of a seal assembly 100 corresponding to the pneumatic vacuum elevator 200 in accordance with an embodiment of the present disclosure. The elevator 200 includes an external cylinder assembly 210 including an elevator cabin 220 inserted therein. The elevator cabin 220 carries one or more users between one or more levels of a structure. In one embodiment, the structure may include a building, vessel or the like.

The external cylinder assembly 210 includes a plurality of cylinders coupled using a base ring assembly 211 and a band ring assembly 212. The base ring assembly 211 provides a supporting layer between other external cylinder assemblies which are connected above or below the top surface and the bottom surface of the external cylinder assembly 210 coupled with the base ring and as a result enables the extension of height pneumatic vacuum elevator based on the requirement. The base ring 211 act as a connecting device for coupling one or more components of the pneumatic vacuum elevator such as the vertical guide rail fitment and the external cylinder assembly for the formation of a compact integrated structure of the pneumatic vacuum elevator. Further, the external cylinder assembly has a band (outer) ring 212 that is used to intact both top and bottom side of the base ring. The band ring 212 is the maximum diameter part in the pneumatic vacuum elevator.

Furthermore, the pneumatic vacuum elevator 200 includes a guide rail pillar 213 mechanically coupled to the elevator cabin. The guide rail pillar is disposed at the external cylinder assembly. The guide rail pillar 213 is configured to guide an actuation of the elevator cabin. The guide rail pillar 213 guides support of the cabin movement in upper and lower side without causing friction and thus reduces anxiety of the passenger within the elevator. The guide rail pillar 213 connects the base ring and provides more strength and rigidity to shaft of the pneumatic vacuum elevator. In addition, the pneumatic vacuum elevator 200 includes a polycarbonate sheet 214 configured to cover the external cylinder assembly 210.

The polycarbonate sheet 214 and the external cylinder assembly is coupled using a first locking device and a second locking device. The first locking device is configured to lock an air gap between the polycarbonate sheet, the base ring assembly, and the external cylinder assembly. The first locking device (not shown in FIG. 5) acts as a tight lock or a hindrance between the base ring and the top and bottom surface of the vertical pillar so that the vertical pillar is constant at its respective position for providing vertical support for smooth functioning of the pneumatic vacuum elevator and moreover reduces the air gap so that any abnormality or distortion during the operation of the pneumatic vacuum elevator is avoided.

The second locking device (not shown in FIG. 5) is configured to lock the air gap between the polycarbonate sheet and the guide rail pillar. The second locking device helps in providing the locking mechanism to the guide rail by avoiding the formation of the air gap which not only keeps the guide rail in an intact position but also does not affect the smooth functioning of the guide rail in guiding the actuation of the cabin of the pneumatic vacuum elevator for transiting. Further, the pneumatic vacuum elevator 200 includes a seal assembly 215 adapted to fit over a top portion of the elevator cabin. The seal assembly 100 is configured to seal the elevator cabin to reduce vibrations during the upward and downward movement of the elevator cabin. The seal assembly 100 includes a covering structure 102. The covering structure 10 is configured to cover a top portion of the elevator 200. The covering structure includes a plurality of pairs of grooves 104 disposed on a peripheral portion of the covering structure 102. Each of the plurality of pairs of grooves 104 is positioned diametrically opposite to each other. The seal mould is 106 operatively coupled with the plurality of pairs of grooves 104. The seal mould 106 is adapted to position on the peripheral portion of the covering structure 102 at a clearance between a wall 108 of each groove of the plurality of pairs of grooves 104 and a sealing material.

The elevator 200 also includes an electronic control unit 215 located on an external cylinder assembly 210 of the pneumatic vacuum elevator 200. In one embodiment, the electronic control unit 215 controls the movement of the elevator 200.

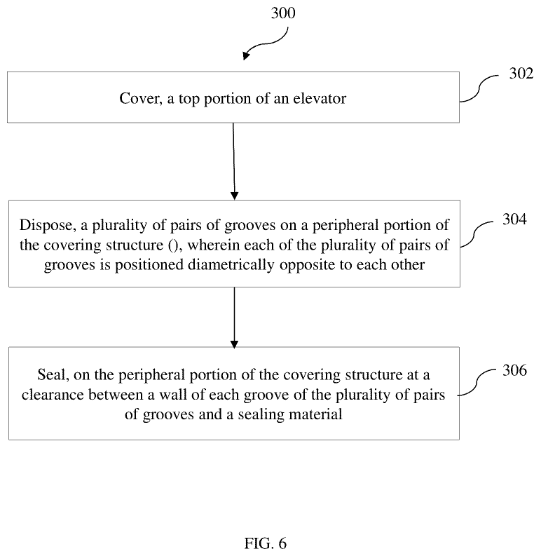

FIG. 6 is a flow chart representing the steps involved in a method 300 to operate seal assembly for the elevator in accordance with an embodiment of the present disclosure. The method 300 includes covering, by a covering structure, a top portion of an elevator in step 302. The method also includes forming, by a circular-shaped covering structure, an arc between two adjacent grooves of the plurality of pair of groves.

The method 300 also includes disposing, a plurality of pairs of grooves on a peripheral portion of the covering structure 102, wherein each of the plurality of pairs of grooves is positioned diametrically opposite to each other in step 304. The method also includes placing the plurality of pairs of grooves equidistantly. The method also includes providing, a plurality of pairs of U-shaped of grooves.

Further, the method 300 includes sealing, by a seal mould, on the peripheral portion of the covering structure at a clearance between a wall of each groove of the plurality of pairs of grooves and a sealing material in step 306. The method also includes sealing, with a rubber material for providing a tight sealing. The method also includes sealing, continuously sealed with the sealing material along a peripheral portion thereof.

Furthermore, the method includes providing, comprises a protruding portion positioned at an offset from a centre portion of the covering structure. The method also includes protruding, by the protruding portion, perpendicularly the covering structure. The method also includes providing, a circular crown positioned at the offset from the centre of the covering structure. The method also includes positioning, a slot positioned adjacent to a groove of the plurality pairs of grooves.

Various embodiments of the system and method to operate the seal assembly for the elevator described above enable a simple assembly which may provide a tight sealing by using a circumferential rubber mold arranged. The seal assembly disclosed in the present disclosure is incorporated into the controls of the elevator systems to provide a smooth riding of the elevator cabin. The seal assembly in the recent disclosure provides easy mounting of sealing material on the elevator cabin.

The present disclosure of seal assembly corresponding to an elevator effectively solves the issue of vibration and sealing.

The system has intelligence, efficient, and energy-saving advantages which result in significant economic benefit and social benefits. The control unit stabilizes the pneumatic elevator and controls on the architectural basis. The control unit also provides high stability and strong anti-interference ability.

Furthermore, there is no intention to be bound by any expressed or implied theory presented in the preceding technical field, background, brief summary, or detailed description. It is also to be understood that the specific devices and processes illustrated in the attached drawings, and described in the specification, are simply exemplary embodiments of the inventive concepts defined in the appended claims. Hence, specific dimensions and other physical characteristics relating to the embodiments disclosed herein are not to be considered as limiting, unless the claims expressly state otherwise.

While specific language has been used to describe the disclosure, any limitations arising on account of the same are not intended. As would be apparent to a person skilled in the art, various working modifications may be made to the method (250) in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A seal assembly 100 for an elevator 200 comprises:
a covering structure 102 configured to cover a top portion of the elevator, wherein the covering structure comprises:
a plurality of pairs of grooves 104 disposed on a peripheral portion of the covering structure 102, wherein each of the plurality of pairs of grooves 104 is positioned diametrically opposite to each other;
a seal mould 106 operatively coupled with the plurality of pairs of grooves 104, wherein the seal mould 106 is adapted to position on the peripheral portion of the covering structure 102 at a clearance between a wall 108 of each groove of the plurality of pairs of grooves 104 and a sealing material.

2. The seal assembly 100 as claimed in claim 1, wherein the covering structure 102 is circular in shape forming an arc between two adjacent grooves of the plurality of pair of groves 104.

3. The seal assembly 100 as claimed in claim 1, wherein the plurality of pairs of grooves 104 comprises U-shaped grooves.

4. The seal assembly 100 as claimed in claim 1, comprises a protruding portion 110 positioned at an offset from a centre portion of the covering structure 102.

5. The seal assembly 100 as claimed in claim 3, wherein the protruding portion 110 is protruded perpendicular to the covering structure 102, wherein the protruding portion 110 comprises a circular crown positioned at the offset from the centre of the covering structure 102.

6. The seal assembly 100 as claimed in claim 1, wherein the sealing material is comprised of a rubber material for providing a tight sealing.

7. The seal assembly 100 as claimed in claim 1, wherein the seal mould 106 is continuously sealed with the sealing material along a peripheral portion thereof.

8. The seal assembly 100 as claimed in claim 1, comprises a slot 112 positioned adjacent to a groove of the plurality pairs of grooves 104.

9. A method 300 comprising:
covering, by a covering structure, a top portion of an elevator; 302
disposing, a plurality of pairs of grooves on a peripheral portion of the covering structure, wherein each of the plurality of pairs of grooves is positioned diametrically opposite to each other; 304 and
sealing, by a seal mould, on the peripheral portion of the covering structure at a clearance between a wall of each groove of the plurality of pairs of grooves and a sealing material. 306

10. A pneumatic vacuum elevator 200 comprising:
an external cylinder assembly 210 comprising an elevator cabin 220 inserted therein, wherein the external cylinder assembly 210 comprises a plurality of cylinders coupled using a base ring assembly 211 and a band ring assembly 212;
a guide rail pillar 213 mechanically coupled to the elevator cabin 220, wherein the guide rail pillar 213 is disposed at the external cylinder assembly 210, wherein the guide rail pillar 213 is configured to guide an actuation of the elevator cabin 220;
a polycarbonate sheet 214 configured to cover the external cylinder assembly 210, wherein the polycarbonate sheet 214 and the external cylinder assembly 210 is coupled using a first locking device and a second locking device, wherein the first locking device is configured to lock an air gap between the polycarbonate sheet 214, the base ring assembly 211 and the external cylinder assembly 210 and the second locking device is configured to lock air gap between the polycarbonate sheet 214 and the guide rail pillar 213;
a seal assembly 100 adapted to fit over a top portion of the elevator cabin 100, wherein the seal assembly 100 is configured to seal the elevator cabin to reduce vibrations during upward and downward movement of the elevator cabin, wherein the seal assembly 100 comprises:
a covering structure 102 configured to cover a top portion of the elevator 200, wherein the covering structure comprises:
a plurality of pairs of grooves 104 disposed on a peripheral portion of the covering structure 102, wherein each of the plurality of pairs of grooves 104 is positioned diametrically opposite to each other; and
a seal mould 106 operatively coupled with the plurality of pairs of grooves 104, wherein the seal mould 106 is adapted to position on the peripheral portion of the covering structure 102 at a clearance between a wall 108 of each groove of the plurality of pairs of grooves 104 and a sealing material; and
an electronic control unit 215 located on top of the external cylinder assembly 210, wherein the electronic control unit 215 controls the movement of the elevator.
